(19) United States
(12) Patent Application Publication
(10) Pub. No.: US 2008/0010669 A1
(43) Pub. Date: Jan. 10, 2008

(54) Hiding in Sh interface

(75) Inventors: Mikko Aittola, Hyvinkie (FI); Jozsef Varga, Nagydobsza (HU)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 11/790,414

(22) Filed: Apr. 25, 2007

Related U.S. Application Data
(60) Provisional application No. 60/795,580, filed on Apr. 28, 2006.

(51) Int. Cl. H04L 9/32

(52) U.S. Cl. 726/3

(57) ABSTRACT

A method is disclosed which comprises: receiving a request for providing identity information of a certain network element, sending access information of a network entry point instead of the identity information of the certain network element. In this way, the identity (e.g., address) of a certain network element can be hidden to the outside of a network (e.g., a third party application server).

### CROSS-REFERENCE TO RELATED APPLICATIONS

This application claims priority of U.S. Provisional Patent Application Ser. No. 60/795,580 filed on Apr. 28, 2006. The subject matter of this earlier filed application is hereby incorporated by reference.

### BACKGROUND OF THE INVENTION

1. Field of the Invention

The invention is related to a method and a device for handling identification data of a certain network element which should be hidden to the outside.

2. Description of the Related Art

The invention is, for example, related to network topology hiding impacts on the Sh interface. The Sh interface is used in IP (Internet Protocol) Multimedia Subsystem (IMS) as the interface between home subscriber server (HSS) and application servers (AS).

In detail, a home subscriber server provides user data to the application server. This user data may include identities of the user, service-related data and the like, and in particular also the name of a serving control network such as a S-CSCF (serving call state control function) serving the user.

An application server may need these data, in particular it may need to know to which S-CSCF a SIP (session initiation protocol) request is to be sent and retrieves it from the HSS. This is effected via the Sh interface. Thus, the application server is able to fetch the S-CSCF address of the user from HSS (see also 3GPP TS 29.328, for example).

In case the application server is operated by the same operator as the particular IMS, it might be acceptable that that the application server obtains specific data of the S-CSCF. However, in case of a third party application server, the operator of the particular IMS might not want to reveal all particulars to the third party.

### SUMMARY OF THE INVENTION

Thus, it is an object to hide a certain network element which may contain delicate data from the outside of a network.

According to an aspect of the present invention, when a network control element, which may manage user related data and the like, receives a request for providing identity information of a certain network element, it sends access information of a network entry point instead of the identity information of the certain network element to the sender of the request.

According to a further aspect of the present invention, a network control element may receive an outgoing message from a certain network element directed to outside a network. The network control element may then check whether the route header comprises identity information to be protected. In case the route header comprises identity information to be protected, the network control element may insert the identity information of a network entry point.

Thus, the identity information (e.g., address) of the certain network element (e.g., a serving network control element) is not revealed to the outside. Thus, the certain network element is hidden to the outside.

### BRIEF DESCRIPTION OF THE DRAWINGS

The invention is described by referring to the enclosed drawings, in which:

FIG. 1 shows a network configuration in which an application server accesses an internet protocol multimedia subsystem (IMS) network according to embodiments of the present invention,

FIG. 2 illustrates a data structure used in the Sh interface between the application server and a home subscriber server (HSS), and

FIG. 3 shows a modification of FIG. 1.

### DETAILED DESCRIPTION OF THE EMBODIMENTS

In the following, embodiments of the present invention is described by referring to the attached drawings.

According to embodiments of the present invention described in the following, hiding procedures are applied in the Sh interface.

In general, the operator may want to hide the network topology (including S-CSCF details) from the other networks because of, e.g., security reasons. This applies for different networks when they are operated by different operators, for example.

As mentioned above, because application servers may be operated by a third party, it may be desirable to apply hiding also to Sh interface procedures. In the following, it is described how this is achieved according to embodiments of the present invention.

According to the embodiments described in the following, an application server (AS) requests the S-CSCF address of a user from a home subscriber server (HSS). The HSS may return, based on operator policy, the address of an entry-point of the network (e.g. interconnection border control function (IBCF), I-CSCF, or other kind of SIP-proxy) instead of the S-CSCF address of the user.

The AS then sends SIP-requests to the entry-point of the network instead of S-CSCF. The entry-point of the network takes care of the routing of the SIP-requests towards the S-CSCF of the user.

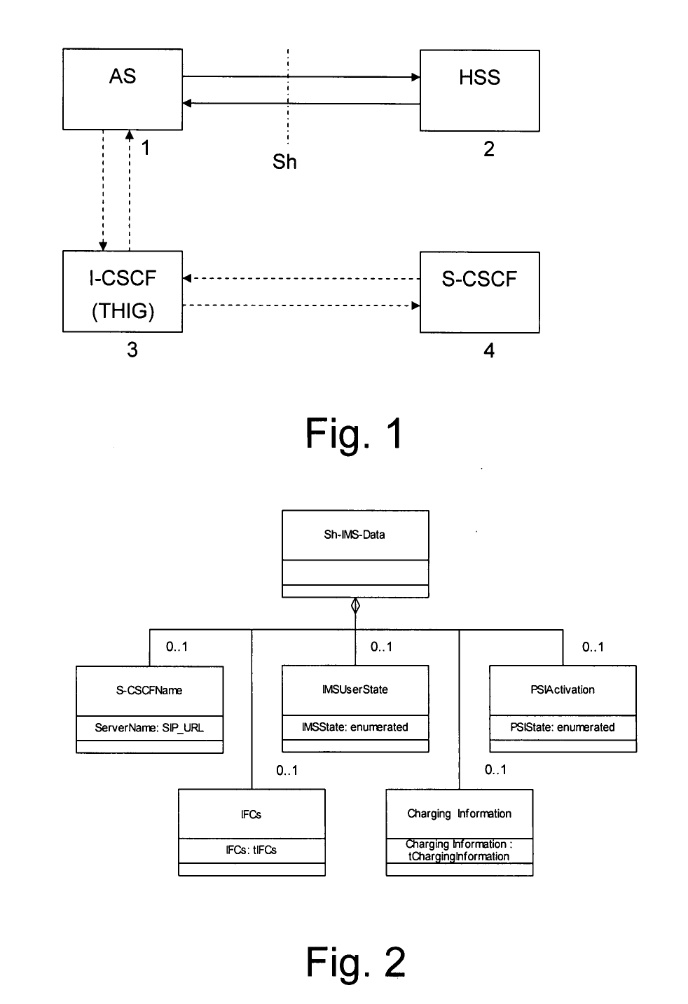

The principle situation according to the embodiments described in the following is shown in FIG. 1.

The network elements involved are an application server (AS) 1 as an example for a network element sending a request for identity information of a certain network element, a home subscriber server (HSS) 2 as an example for a network control element which stores user related data and the like, an I-CSCF (interrogating call session control function) 3 as an example for network entry-point, and a S-CSCF (serving call session control function) 4 as an example for a serving network control element.

It is noted that according to a specific example of the present embodiment, the I-CSCF acts as a topology hiding inter-network gateway (THIG), hence, it is denoted as I-CSCF (THIG) in FIG. 1. This specific example is applicable to release 5 and 6, for example.

The different elements may be constructed by a computer comprising a processor (e.g., a CPU), non-volatile memory (e.g., ROM, harddisk or the like), a volatile memory (e.g., RAM) and the like. Moreover, the elements may comprise one or more physical interfaces which act as sender and/or receiver in order to establish contact with other network elements.

The application server is configured to host and execute services. The application server can influence and impact a SIP session on behalf of the services and it uses the Sh interface to communicate with the HSS.

The Sh interface is able to support subscription to event notifications between the Application Server and HSS to allow the application server to be notified of the implicit registered public user identities, registration state, assigned S-CSCF name, and user equipment (UE) capabilities and characteristics in terms of SIP User Agent capabilities and characteristics.

It is noted that in this case, the Sh interface is not only used as an intra-operator interface (as it would be for application servers of the same operator), but also as an inter-operator interface (for third party application servers).

According to the embodiments, the application server 1 may request the home subscriber server 2 to provide it with information regarding the S-CSCF 4. The request is sent via the Sh interface between the application server 1 and the home subscriber server 2. The messaging regarding this request is indicated in FIG. 1 by straight arrows.

Thus, the application server 1 receives the address information of the I-CSCF 3 as the network entry point. That is, information is exchanged between the application server and the S-CSCF 4 only via the I-CSCF 3. This information exchange is indicated in FIG. 1 by dashed arrows.

According to a first embodiment, the application server 1 receives the address information of the I-CSCF via a certain data structure as defined in the Sh interface. An example for such a data structure may the class Sh-IMS-Data of the UML model, which is shown in FIG. 1.

Each instance of the class Sh-IMS-Data contains 0 or 1 instance of the class S-CSCFName, 0 to n instances of the class InitialFilterCriteria, 0 or 1 instance of the class IMSUserState, 0 or 1 instance of the class ChargingInformation and/or 0 or 1 instance of the class PSIActivation.

Class S-CSCFName contains a SIP URI. The S-CSCF name identifies the S-CSCF of the user, and may comprise an address thereof. According to the present embodiment, however, this information element contains, based on operator policy, either the name of the S-CSCF where a multimedia public identity is registered, or the entry point of that network. That is, according to the present embodiment, the operator of the network has the choice to reveal the name of the S-CSCF or to hide it from the outside, i.e., from third partys.

The remaining fields are shortly described in the following: Class IFCs contains 0 to n instances of the initial filter criteria of the multimedia public identity that the AS included in the request. Class IMSUserState contains the registration state of the identity given by the attribute of class Sh-IMS-Data. Class Charging Information contains the online and offline charging function addresses. Class PSIActivation contains the activation state of the Public Service Identity given by the attribute of class Sh-IMS-Data.

Thus, when the access points uses the address of the network entry point (such as that of the I-CSCF), the S-CSCF can be hidden. In this way, the I-CSCF acts as a topology hiding inter-network gateway (THIG) or interconnection border control function (IBCF).

Upon receiving an outgoing request/response from the hiding network the I-CSCF (THIG or IBCF) shall perform the encryption for topology hiding purposes, i.e. the I-CSCF shall:

1) use the whole header values which were added by one or more specific entity of the hiding network as input to encryption, besides the user equipment (UE) entry;

2) not change the order of the headers subject to encryption when performing encryption;

3) use for one encrypted string all received consecutive header entries subject to encryption, regardless if they appear in separate consecutive headers or if they are consecutive entries in a comma separated list in one header;

4) construct an network access identifier (NAI) in the form of ‘username@realm’, where the username part is the encrypted string, and the realm is the name of the encrypting network;

5) append a “tokenized-by=” tag and set it to the value of the encrypting network's name, after the constructed network access identifier (NAI);

6) form one valid entry for the specific header out of the resulting NAI, e.g. prepend “SIP/2.0/UDP” for Via headers or “sip:” for Route and Record-Route headers; and

7) if the Route header includes entry for the hiding network, then insert its own URI before that.

Thus, according to the first embodiment, it is possible to hide the S-CSCF addresses of the users from e.g. third party application servers. Moreover, no changes to the application server and no changes to Sh interface XML schema are required, since the existing field containing the S-CSCF name is rewritten.

In the following, a second embodiment is described. According to the second embodiment, the operator utilizes the Sh permission list to prevent an AS to fetch S-CSCF address from HSS.

The Sh permission list (or application server (AS) permission list) defines which kind of information or which data an application server is allowed to receive from the HSS. The permission list is maintained by the HSS.

According to the present embodiment, a new Sh data-reference for the address of the entry-point to the network is defined. The application server is then able to fetch the entry-point address from HSS.

Hence, according to the present embodiment, it is defined in the permission list that the application server is allowed to receive the address of the network entry-point (e.g., I-CSCF).

Therefore, the application server will access the network entry-point instead of the S-CSCF.

Thus, also according to the second embodiment, it is possible to hide the S-CSCF addresses of the users from e.g. third party application servers.

In the following, a third embodiment of the invention is described. The third embodiment is similar to the first and second embodiments described above, with the following exception:

Similar as in the second embodiment, the operator utilizes the Sh permissions list to prevent an AS to fetch S-CSCF address from HSS. According to the third embodiment, it shall be possible for the operator to configure the network entry-point address directly to the AS.

This could be implemented using the following possibilities:

The AS operator may configure and store a “global” entry-point address to the application server that is used for all requests. In this case, the application server is able to offer service to one IMS network only.

Alternatively, the application server operator configures and stores entry-point address to the application server based on the host-part of the SIP-URI of the users. For example, there would be an entry-point address for network ‘example.com’ and the application server would use this address for all users that belong to ‘example.com’ network, for example for joe@example.com.

Further alternatively, the application server contains storage for subscriber specific entry-point address and the operator configures entry-point address for each user. The application server then fetches this address when it sends a request on behalf of the user.

Another alternative would be that the AS makes a domain name system (DNS) query and the DNS is configured so that the entry-point address is returned. This assumes that the DNS service that contains the right configuration is available for the AS.

Thus, also according to the third embodiment, it is possible to hide the S-CSCF addresses of the users from e.g. third party application servers. Moreover, since according to the third embodiment the network entry-point address is directly configured to the application server, no changes to HSS and no changes to Sh interface XML schema are required.

In the following, a fourth embodiment is described. This embodiment is similar to the third embodiment, with the following exceptions:

In particular, according to the fourth embodiment, the solution described above can also be used to send the entry-point address of the user's network to the AS (instead of S-CSCF address) in case there is no S-CSCF assigned for the user HSS.

This means that the operator can configure the HSS to send the address of the entry-point of the network to the AS in case the user has no S-CSCF assigned. But if S-CSCF is assigned for the user the HSS sends the S-CSCF address to the AS.

Hence, according to this embodiment, the solution is useful also inside operators own network. In such case there might be no need to hide the S-CSCF address from the AS. A further benefit is that, if there is no S-CSCF assigned for the user, and HSS sends the address of the entry-point of the network to the AS, the AS is able to send the request to this entry-point which could then apply the S-CSCF selection procedures described in 3GPP TS 29.228 and select S-CSCF for the user.

Moreover, it is also possible that the entry-point of the network does not select the S-CSCF itself but instead the entry-point forwards the request to a network entity that then selects the S-CSCF for the user.

The invention is not limited to the embodiments described above, and various modifications are possible.

For example, the embodiments may be combined.

In this way, the security may be enhanced since different mechanisms to hide the address of the network control element (e.g., the S-CSCF) are applied at the same time.

Furthermore, in the above embodiments, an I-CSCF was described a network entry-point. However, the invention is not limited to this. The network entry-point can be an IBCF, another kind of SIP-proxy or any other suitable network element.

Furthermore, according to the embodiments, the Sh interface was described. However, the invention is not limited thereon. For example, any kind of interface may be used between the HSS and the application servers which use Sh Diameter commands as defined in 3GPP 29.328 and 29.329 to request and notify information, for example. However, the invention is also not limited to these Diameter commands, any suitable form for the commands may be applied.

Furthermore, in the inter-operator case (e.g., a third party application server), there might be one or more Diameter proxy or relay nodes between the HSS and application server.

For example, also an IP multimedia subsystem service control interface (ISC) may be applied. The ISC interface is between the S-CSCF and the service platform(s) such as application servers. Thus, according to a modified embodiment, based on operator preference, border control functions may be applied between two IM CN subsystem networks or between an IM CN subsystem network and a stand-alone AS. Thus, the ISC may be a reference point between a CSCF/IBCF and an application server or another network.

That is, according to this modification, an interconnection border control function (IBCF) 5 is used between the application server 1 and the S-CSCF 4, as shown in FIG. 5. The remaining elements are the same as shown in FIG. 1. This configuration could be used for rel. 7, for example.

Moreover, in the above embodiments, an application server was described. However, the invention is not limited thereon. For example, the entity offering the services may also be another network. Furthermore, instead of the application server, also an internet protocol (IP) multimedia service switching function (IM SSF), an open service architecture service capability server (OSA SCS) or the like may be applied.

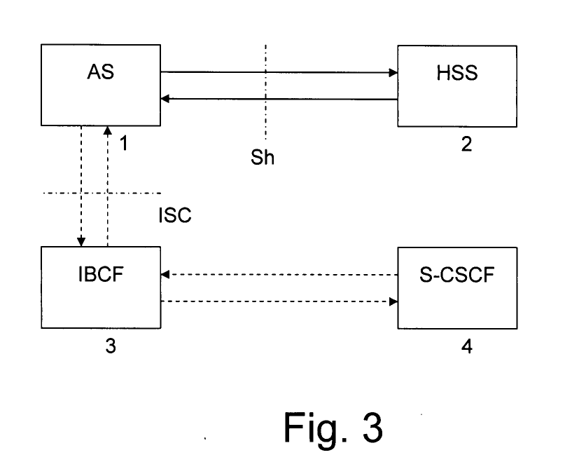

Furthermore, the procedures of the embodiments of the invention may be implemented as a computer program product which comprising processor implementable instructions for performing the procedures of the above embodiments. In particular, the computer program product may comprise a computer-readable medium on which the software code portions are stored, and/or the computer program product is directly loadable into an internal memory of a network element. The computer program product may be used in one or more of the network elements involved. That is, the computer program may be executed by the processor of the home subscriber server 2 shown in FIG. 1, for example, or by the I-CSCF 3 shown in FIG. 3, for example, or by another suitable network element(s).

According to embodiments of the present invention a method is provided comprising

receiving a request for providing identity information of a certain network element,

sending access information of a network entry point instead of the identity information of the certain network element.

In the method, the certain network elements may be a serving network control element.

In the method, a data structure may be defined, and a field of the data structure contains an identification of the certain network element, the method comprising

writing the access information of the network entry point in the field for the identification of the certain network element.

In the method the data structure may be a part of a definition of an interface.

In the method, the access information of the network entry point is an address information of the network entry point.

In the method, the network entry point may be a network control element.

In the method, the identity information of the certain network element may comprise address information.

The method may further comprise:

providing a permission list for allowing or not allowing whether the identity of the certain network element is provided to a sender of the request.

The method may further comprise:

including a data reference for the address of the network entry point into the permission list.

The method may further comprise:

configuring the network entry-point address directly to a sender of the request.

In the method, a sender of the request may be an application server.

Furthermore, a method is provided comprising:

receiving an outgoing message from a network element directed to outside a network,

checking, whether the route header comprises identity information to be protected, and,

in case the route header comprises identity information to be protected, inserting the identity information of a network entry point.

According to embodiments of the invention, a device is provided which comprises

a receiver configured to receive a request for providing identity information of a certain network element, and

a sender configured to send access information of a network entry point instead of the identity information of the certain network element.

In the device, the certain network elements may be a serving network control element.

In the device a data structure may be defined, and a field of the data structure may contain an identification of the certain network element, wherein the device may be configured to

write the access information of the network entry point in the field for the identification of the certain network element.

In the device, the data structure may be a part of a definition of an interface.

In the device, the access information of the network entry point may be an address information of the network entry point.

In the device, the network entry point may be a network control element.

In the device, the identity information of the certain network element may comprise address information.

The device may further comprise a permission list for allowing or not allowing whether the identity of the certain network element is provided to a sender of the request.

Furthermore, a data reference for the address of the network entry point may be included into the permission list.

The network entry-point address may be configured directly to a sender of the request.

The device may be a home subscriber server.

The sender of the request may be an application server.

According to embodiments of the invention, a device is provided which comprises

a receiver configured to receive an outgoing message from a network element directed outside a network, and

a controller configured to check whether the route header comprises identity information to be protected, and, in case the route header comprises identity information to be protected, to insert the identity information of a network entry point.

Furthermore, according to embodiments of the invention, a computer program product for a computer is provided, comprising software code portions for performing the steps of any one of the method aspects described above when the program is run on the computer.

The computer program product may comprise a computer-readable medium on which the software code portions are stored.

The computer program product may be directly loadable into an internal memory of the computer.

The computer may be incorporated in a controller of a network element.

It is noted that the different aspects of the embodiments described above may be combined arbitrarily.

1. A method comprising:
receiving a request for providing identity information of a certain network element; and
sending access information of a network entry point instead of the identity information of the certain network element.

2. The method according to claim 1, wherein the certain network elements is a serving network control element.

3. The method according to claim 1, wherein a data structure is defined, and a field of the data structure contains an identification of the certain network element, the method comprising:
writing the access information of the network entry point in the field for the identification of the certain network element.

4. The method according to the claim 3, wherein the data structure is a part of a definition of an interface.

5. The method according to claim 1, wherein the access information of the network entry point is an address information of the network entry point.

6. The method according to claim 1, wherein the network entry point is a network control element.

7. The method according to claim 1, wherein the identity information of the certain network element comprises address information.

8. The method according to claim 1, further comprising:
providing a permission list for allowing or not allowing whether the identity of the certain network element is provided to a sender of the request.

9. The method according to claim 8, further comprising including a data reference for the address of the network entry point into the permission list.

10. The method according to claim 1, further comprising:
configuring the network entry-point address directly to a sender of the request.

11. The method according to claim 1, wherein a sender of the request is an application server.

12. A method comprising:
receiving an outgoing message from a network element directed outside a network;
checking, whether the route header comprises identity information to be protected; and
in case the route header comprises identity information to be protected, inserting the identity information of a network entry point.

13. A device comprising:
a receiver configured to receive a request for providing identity information of a certain network element; and
a sender configured to send access information of a network entry point instead of the identity information of the certain network element.

14. The device according to claim 13, wherein the certain network elements is a serving network control element.

15. The device according to claim 13, wherein a data structure is defined, and a field of the data structure contains an identification of the certain network element, wherein the device is configured to:
write the access information of the network entry point in the field for the identification of the certain network element.

16. The device according to claim 15, wherein the data structure is a part of a definition of an interface.

17. The device according to claim 13, wherein the access information of the network entry point is an address information of the network entry point.

18. The device according to claim 13, wherein the network entry point is a network control element.

19. The device according to claim 13, wherein the identity information of the certain network element comprises address information.

20. The device according to claim 13, further comprising a permission list for allowing or not allowing whether the identity of the certain network element is provided to a sender of the request.

21. The device according to claim 20, wherein a data reference for the address of the network entry point is included into the permission list.

22. The device according to claim 13, wherein the network entry-point address is configured directly to a sender of the request.

23. The device according to claim 13, wherein the device is a home subscriber server.

24. The device according to claims 13, wherein a sender of the request is an application server.

25. A device comprising:
a receiver configured to receive an outgoing message from a network element directed to outside a network; and
a controller configured to check, whether the route header comprises identity information to be protected, and, in case the route header comprises identity information to be protected, to insert the identity information of a network entry point.

26. A computer program product embodied on a computer readable medium, the computer program comprising software code portions for controlling a processor to execute a method comprising:
receiving a request for providing identity information of a certain network element; and
sending access information of a network entry point instead of the identity information of the certain network element.

27. The computer program product according to claim 26, wherein the computer program product is directly loadable into an internal memory of the computer.

28. The computer program product according to claim 26, wherein the computer is incorporated in a controller of a network element.

29. A computer program product embodied on a computer readable medium, the computer program comprising software code portions for controlling a processor to execute a method comprising:
receiving an outgoing message from a network element directed outside a network;
checking, whether the route header comprises identity information to be protected; and
in case the route header comprises identity information to be protected, inserting the identity information of a network entry point.

30. The computer program product according to claim 29, wherein the computer program product is directly loadable into an internal memory of the computer.

31. The computer program product according to claim 29, wherein the computer is incorporated in a controller of a network element.

32. A device comprising:
means for receiving a request for providing identity information of a certain network element; and
means for sending access information of a network entry point instead of the identity information of the certain network element.

33. A device comprising:
means for receiving an outgoing message from a network element directed to outside a network; and
means for checking whether the route header comprises identity information to be protected, and for inserting the identity information of a network entry point, in case the route header comprises identity information to be protected.
